(19) United States
(12) Patent Application Publication
(10) Pub. No.: US 2004/0013780 A1
(43) Pub. Date: Jan. 22, 2004

(54) Manufacturing process of spheroidal food dyes

(76) Inventor: Ramakant Jagdishprasad Tibrewala, Gokuldham (IN)

Correspondence Address: SPENCER, FANE, BRITT & BROWNE, 1000 WALNUT STREET, SUITE 1400, KANSAS CITY, MO, 64106-2140, US

(21) Appl. No.: 10/432,719

(22) PCT Filed: Dec. 29, 2000
(86) PCT No.: PCT/IN00/00134

(51) Int. Cl. A23L 1/27

(52) U.S. Cl. 426/540

(57) ABSTRACT

The process of manufacturing spheroidal shaped granules using mixture of liquid food colour (comprising of FD & C dyes, Acid dyes, D & C dyes, artificial dyes and blends of artificial dyes) which is first spray dried, then pulverized and then blended with water to form noodles which are cut into an uniform size through an adjustable cutter. These uniform sized noodles are thereafter subjected to a spherodizer containing a bowl with a plate bottom wherein the noodles are subjected to a centrifugal action which makes the noodles to collide with the wall of the bowl and return back to the center of the bowl. This continuous action of hit and cut transforms the noodles into spheroidal shaped granules which are then dried and sieved in a vibratory sifter to obtain spheroidal granules having high rate of solubility, do not disintegrate into dust form and are easier to handle.

### FIELD OF THE INVENTION

This invention relates to the manufacturing process of spheroidal shaped dye granules, more particularly a spheroidal shaped food dye granule made from food colors (comprising of FD & C dyes, Acid dyes, D & C dyes, artificial dyes and blends of artificial dyes).

The objective of the present invention is to produce dust less, easily soluble, porous, uniformly spheroidal shaped granules of food colors (comprising of FD & C dyes, Acid dyes, D & C dyes, artificial dyes and blends of artificial dyes).

### BACKGROUND OF THE INVENTION

Till the 1950's, artificial food color was only available in powder form which was a continuous source of problems like air borne color dust and cross contamination to the food manufacturers and food processors. The powder form of artificial food colors is very light in weight and fluffy in nature which is easily dispersible in air and floats with it. As a result when the powder form of color is being weighed and dissolved in the appropriate medium, it easily taints the skin of the workers, clothing, walls, floors and machinery around it (air borne color pollution) while also contaminating the other products (cross contamination) being manufactured within the premises. To overcome this problem of color dust and cross contamination, food manufacturers and food processors started investing in Dust Controlling equipments and isolating the areas where powder color was being weighed and dissolved. While other manufacturers changed their production schedules to control the problem of cross contamination. They started their production with lighter colors first and gradually moving towards usage of darker colors.

The problem of airborne color dust and cross contamination of colors led the manufacturers of artificial food colors to develop new processes through which products could be produced that are dust free, do not contaminate the surroundings, workers, machine and other products and at the same time are easy to weigh and use. Some of the processes developed to obtain dust free products are as follows:

1. Process of manufacturing Liquid Food Colors: In this process the powder form of food color is dissolved in water and the resulting solution is further treated with preservatives for prolonged shelf life. Though the product obtained through this process checked the problem of air borne color dust and cross contamination, there were added disadvantages. At low temperatures, the color formed sediment at the bottom of container due to lower rate of solubility. Also the color concentration is very less (varying from 10% to 30%) in the product developed which is directly proportional to the solubility of the aqueous medium resulting in weaker shades. To obtain strong shades, food manufacturers/processors had to increase the dosage of the color. Over all of these, was the increased cost of handling and transportation.

2. Process of manufacturing Paste Colors: As per this process, the powder food color is dispersed in Glycerin or Propylene Glycol with Dextrose as the thickening agent. Though the product obtained is dust free, is able to check the problem of cross contamination and is easy to transport at ambient temperatures but had added disadvantages. At low temperatures, it has a tendency to crystallize and at high temperatures melts down, resulting in stickiness. Besides it is meant for very specific applications, is undesirable for water based products and is difficult to measure accurately. The factor of higher costs remains.

3. Process of manufacturing Dry Compacted Granules: As per this process the powder food color is compacted at high pressure and temperature to form a continuous sheet which is further crushed into small grains. Though the product obtained is dust free but has been found to generate lot of dust during handling and transportation. The grains are coarse, irregular in size and shape with sharp edges. These edges rub against each other during transit thereby breaking down the edges and regenerating dust.

4. Process of manufacturing Wet Mix Extruded Granules: As per this process, the powder form of food color is mixed with water, thereby extruding the wet mix through an extruder, followed by drying and screening thereafter to eliminate fine particles. Being elongated, strand like in shape, this product developed through this process takes longer time to dissolve and tends to regenerate dust during transportation and handling.

5. Process of manufacturing Agglomerated Granules: As per this process, the agglomerated granules are manufactured by agglomerating, drying and screening the liquid dye slurry to obtain larger particles. The product produced by this process though is highly porous and easily dissolving, is also easily friable. Agglomerated products are by nature, irregularly shaped particles with angular edges which can catch on each other as they are subject to shear forces during handling and shipping, breaking up the “dust free” agglomerate and reintroducing dust into the product. The manufacturing process is capital intensive, equipment maintenance is time consuming and expensive. Manufacture of blended dyes and low volume dyes is economically unviable because of its high throughput, thus making this process suitable for high volume dyes only. Although this product developed through this process had improved the solubility rate significantly, it failed to address the subsequent airborne color dust during usage/application.

The above mentioned manufacturing processes focused on eliminating the problem of dust generation during transportation and handling, elimination of air borne color dust and cross contamination at the production site, easy to dissolve in water at ambient temperature but had added disadvantages.

The objective of our research was to develop a process that will eliminate the cause of breakage of edges which is the prime reason for dust generation during transit when the finished product has all the characteristics of a dust free product. It was learnt during the course of our research that the granules break up at edges due to drying, friction amongst themselves, the resultant effect of sudden high impact of pressure from opposite end when dropped/shaked etc. Shape factor so selected was to have no sharp edges/corners to disintegrate with small impaction or abrasion thereby resulting in dusty product which also has maximum solubility that requires large area contact between solvent and solute which ultimately resulted from spherical shape only. It was also observed that when the spheroids undergo friction within themselves, their spherical surfaces skip the impact due to the homogenous bonding thereby saving the surface from breaking down.

Under the prior art, a food dye granule is prepared from food colors (comprising of FD & C dyes, Acid dyes, D & C dyes, artificial dyes and blends of artificial dyes) wherein the raw materials are subjected to the following steps viz. drying of the slurry, reduction of the dried product into an ultra fine state in a Pulveriser, charging the powder by a process of Compacting, transforming the compacted material into a Cadmill, where the same is run through and crushed by rotating blades to get granules of desired size, charging the Cadmilled material to a Vibratory Sifter for uniform segregation of granules. The food dye granules obtained by the aforementioned process had certain shortfalls in that the dye granules are irregular in shape and size, having sharp edges which had a tendency to easily disintegrate into dust form (as they are formed by dry compaction process) making it difficult to handle.

Quite a number of processes have claimed to achieve the target of dust free dye granules (WO 98/17729 of CIBA SPECIALTY, Switzerland; WO 89/00079 of ICI Australia; U.S. Pat. No. 5,507,991 John R. Mudd; U.S. Pat. No. 3,579,719 Nobuharu Moriya; FR 2645 164 Bayer AG; U.S. Pat. No. 3,775,331 G. Borrello; FR 2179 137 Ciba Geigy AG, Switzerland). All except one (U.S. Pat. No. 5,507,991 John R. Mudd) are from the non food industry, the products varying from organic pigments for plastic industry, dye granules for pesticides, enzymatic compositions for detergents, coloring granules for textile/paper/leather industry, water dispersible dye granules for agricultural chemicals etc. Moreover it has been observed that most of these processes use surfactants like soaps, salts of aliphatic monoesters or sulphuric acid such as sodium lauryl sulphate, salts of sulphonated aromatic compounds etc., wetting agent like alkyl naphthalene sulphonates, phosphate esters etc., dispersing agents like condensate aromatic sulphonic acids such as naphthalene-sulphonic/formaldehyde acid, sulphone ligning etc., filler component like mineral earths and clays etc. to develop dust free dye granules which rules out totally its applicability in Food industry.

The known processes of manufacturing dye granules that are dust free and have been cited as similar to “Manufacturing process of Spheroidal shaped food dye granule” are detailed as herewith:

A. “Extrusion method for producing FD&C dyes” (U.S. Pat. No. 5,507,991 by John R. Mudd) is a known method for producing stranded FD&C dyes which comprises the steps of: drying a solution of FD&C dye to produce a powder, combining said powder with water in a relative weight percentage amount sufficient to form an extrudable mixture, extruding said mixture to produce a stranded dye product and, sifting said stranded dye product to produce a stranded granular dye product. But strands thus formed are non uniform and generates dusty surface which also takes longer time to dissolve in liquid medium. The process of extrusion is done through a die plate having a plurality of passage ways wherein the entry bore is smaller than the exit bore of the said passage ways with the expressed limitation that the ratio of the entry bore to exit bore diameters is about 1:1.2. The strands are produced by extrusion through the die plate using a single screw extruder operating at about 2.07·10⁷ Pa (3000 psi) to 3.45·10⁷ Pa (5000 psi).

B. “Water dispersible granules” (ICI Australia Operations Proprietary Limited, Australia—WO89/00079), as with agricultural chemicals, minerals etc. comprises of the steps of mixing the desired ingredients into an extrudable form with dough like consistency, extruding the wet mix and then rolling the wet extrusions and optionally drying, if required. Along with the active ingredients, surfactants and fillers are used to form granules of substantially uniform length. The dough like consistency is provided through mixing or kneading using a mixing apparatus such as Pug Mill, double shafted Auger or an extrusion apparatus adapted to provide suitable mixing. After extruding the wet mix through suitable orifices, the wet extrusions are broken down by rolling preferably in a tumbling action. The extrusions vary considerably in length, for example up to 8 cm or more long. The tumbling action is used to make smaller sized, likely to be uniform in shape which rather results in dusty nature and roughly uniform in size with a length generally not exceeding three times their diameter. This process claims to achieve high production rates with the products having high suspension and rapid dispersion.

C. “Coloring granules of the stable form, non dusty and their preparation procedure” (CIBA GEIGY AG, Switzerland—FR 2179 137). These granules are characterized by the fact that they contain one or more coloring agents soluble in water and in comparison to the total weight of the granules 0.1 to 20% in weight of a dispersing agent and/or a wetting agent, 5 to 50% in weight of a binding agent and 0 to 50% in weight of other additives. Though the CIBA invention discusses manufacture of coloring granules which on one hand have enough cohesion of the particle and on the other hand unaltered solubility, the solubility of the granules is adjusted at the time of manufacturing with the help of binding agents, dispersing agents or the wetting agents and other additives, so that the granules have a stable form and are not friable and remain regarding the wetting or the solubility, in conformity to the requirements of the application. The point to be noted is achieving unaltered solubility and cohesion of the particles within themselves by the use of dispersing agents and other additives which are not permissible in the food industry. The process of granule formation involves mixing a pressed cake of the coloring agent and the definite components (like dispersing/wetting agent, a binding agent, a charge agent and other additives) in a mixing bowl, then granulating the paste with the help of a granulating machine followed by drying with hot or cold air under controlled temperature as the reactant coloring agent is highly sensitive. The granulating machine comprises of a granulation drum (roller) wherein the product is put or on a plate by spraying a solvent (like water, alcohol etc.) simultaneously to obtain granules in different shapes like grains, flakes, spheres, cylinders, tablets etc.

D. “Pigment Granulation” (CIBA SPECIALTY CHEMICALS HOLDING INC, Switzerland—WO 98/17729). This invention relates to a process for preparing organic pigment granules with particle size from 0.5 mm to 4.0 mm, comprising of a mixture of at least one organic pigment, a binder having a neutral emulsifier which is soluble clearly in water or a C1-C4 alcohol. The mixture is pressed in a continuously operating apparatus through one or more apertures each having a 0.2 mm² to 5.0 mm², the apparatus consisting of one conveying device and a shaping section comprising of apertures and being constructed and operated with a throughput such that the pressure in its shaping section does not exceed 10 bar. If desired—the cylindrical granules emerging from the dies are converted on a rotating device into ovoid or spherical granules. The granulated product is dried at a temperature of −50° C. to 200° C. at atmospheric pressure or under reduced pressure. The cylindrical extrudates usually break up on their own accord on emergence from the shaping section into pieces with a length of about 2 mm to 6 mm. The rotating device which converts the cylindrical granules into spherical granules can be for example a plate, a hollow cylinder or like. The cylindrical material emerging from the extruder is preferably passed directly onto roughly the center of the rotating device, centrifugal force setting the cylindrical granules into a rolling movement and so converting them into more or less spherical granules. Conversion into ovoid or spherical granules is optional. The granulated product is dried batch wise or continuously (in this case the material is conveyed on a conveyor belt through an oven which is open at both ends and is at a temperature of 100° C. to 200° C.). On account of its properties, the pigment granules are highly suitable for pigmenting high molecular mass organic material esp. plastics and coatings.

E. “Apparatus and Method for making Spherical Granules” (Fuji Denki Kogyo Co. Ltd. Japan, U.S. Pat. No. 3,579,719). This invention is related to the method and apparatus for making spherical granules from wetted cylindrical granules wherein the equipment facilitates convenience in the handling process and security as well as in mixing, scattering process and packaging of insecticides, pesticides, cattle feed, medicines, chemicals etc. It also facilitates an increase in product yield by preventing the wet pellets from being agglomerated and being crushed into fines in powdered form. The claimed apparatus consists of an indenting rotating plate at the bottom of a cylinder, a horizontal dispersing arm spaced from the round indented plate, vertical stream changing blades standing at both edges of the horizontal dispersing arm which rotates adjacently to the inner surface of the cylinder, means to rotate the shaft of the indented plate at high speed while the horizontal dispersing arm and stream changing blades rotate in the opposite direction at low speed. As per this process, the material is added with suitable agglomerating agent is charged into the pelleter wherein cylindrical wet extrusions are produced which are sticky in nature and tend to adhere on the inner surface of the wall resulting in large sized irregular, spherical agglomerated mass. These wet extrusions are fed into the invented apparatus where they are propelled into a rotary motion on contacting the protuberances on the rotating plate which reduces the amount of unwanted agglomeration. The horizontal dispersing arm and stream changing blades effect the bed of pellets causing them to rotate in a twisting, rotating fashion, turning the pellets into the center of the indented plate.

F. “Manufacture of enzyme spheres” (Colgate Palmolive Co., USA, U.S. Pat. No. 3,775,331). This process relates to enzymatic compositions in spherical form, more particularly to a method of making such compositions and blends thereof with other detergent constituents to make effective enzymatic cleaning compositions. The enzyme particles include a carrier material, for example an inorganic salt with the organic content. The method of manufacturing involves mixing of various enzyme bead constituents in a mixer or amalgamator in dry or semi-dry state. Water or other plasticizing chemicals are added only in small quantities to blend it with other ingredients. Thereafter the particulate mixed material is charged to a plasticizing device such as a kneader or a mill which will have from 5 to 7 rolls to convert the mass into a plastic film, extrudate or chip. The milling or kneading operation helps to distribute the enzyme throughout the surface active agent and facilitates coating of the enzyme with a film of the more plastic, waxier surface active material. Ribbons or chips produced are discharged from the kneader to a plodder or other suitable extruder to obtain the enzyme composition in filament or rod form. The heat generated during the process causes substantial moisture loss which is diminished by cooling the mill rolls and the extruder by circulating cold water through the rolls or inside the extruder screws. Moisture addition at this stage also facilitates the mix to become more plastic which in turn promotes the discharge of continuous filaments of enzyme composition. The filaments are then charged into the spherulizing machine which breaks the filaments into small sections from which the desired spheres could be prepared. If the extruded filaments are not sufficiently plastic, then they are corrected by heating or moistening slightly as required before being charged into the spherulizing machine. This machine comprises of a horizontally rotating frictional plate whose function is to impart a whirling motion to filaments or rods or broken products of such filaments and spheres, which are less than twice the filamentary diameter. The rounding of such particles takes place by contact with the whirling plate, the sides of the dish, the internal machine wall and other particles. The plasticity of the filaments or rods will be such that these resemble a comparatively soft soap, just firm enough to maintain their shape but not so plastic as to adhere to other particles to form larger aggregates. The desired plasticity may be obtained by additions of moisture by addition of a fine stream of water to the bed or by evaporation of water from the moving bed. A dye may be added to this water to color the particles at a suitable stage in their processing.

G. “The procedure for production of coloring granules” (Bayer AG, Germany, FR 2645 164) is also a known method wherein the coloring powder having water content from 5% to 15% in weight are subjected to granulation by extrusion. The extrusion is carried out by means of flat matrix press producing the desired length of strands. Which optionally has dispersing agents, diluents, dust removing agents, emulsifying agents, granulation liquid etc. These coloring granules have application in the textile industry, paper industry and leather industry. As per the manufacturing process, the water is sprayed on the color powder with optional addition of the additives. Flat matrix press is used where the flat matrix and cylinders are the compression tools. The color mixture is introduced vertically down in a measured quantity in the room of the press and forms a layer of the material on the matrix. The cylinders roll on this layer and cause its compacting. The force of compacting increases constantly when the cylinders roll in the direction of the channel of the press till it becomes so high that the product is compressed by the rotational cylinders through the ejection grid serving as the matrix and forms the strands. The adjustable cutting device below the matrix cuts the strands into desired lengths. Drying is not mandatory.

The known processes to produce dust free dye granules for the food industry have not been able to meet the market expectations of a dust free dye granule that does not generate dust during transit or handling. This industry requires specialized products that are highly safe and hygienic for internal consumption and external application in any form for human beings. Every country has drawn up legislative standards for certification of such products before they are introduced in the market. The manufacturing process of dust free dye granules for the food industry has to ensure the above concerns.

### DESCRIPTION OF THE INVENTION

To overcome the aforementioned shortcomings as discussed under “BACKGROUND OF THE INVENTION”, a new process for manufacture of dye granules using artificial food colors (comprising of FD & C dyes, Acid dyes, D & C dyes, artificial dyes and blends of artificial dyes) has been developed which has certain characteristics viz. all the dye granules/spheroids are spheroidal in shape and are uniformly sized, do not disintegrate or form dust while handling or transportation. The spheroids have high solubility, reduced abrasion, and low friability. Being of uniform size and the shape factor, are highly resistant to disintegration, hence best for handling. The spheroidal dye granules made by the above referred inventive process are developed on a simple principle wherein the powder is compacted in the presence of binding fluid to form spheroidal shaped uniform beads which have no sharp edges to break off to create color dust. The range of the dye beads which can be processed by this invention are between 0.8128 mm (0.032 inches) to 7.112 mm (0.28 inches).

By this process, dye granule is prepared from artificial food colors (comprising of FD & C dyes, Acid dyes, D & C dyes, artificial dyes and blends of artificial dyes) wherein the raw materials are subjected to the following steps viz. spray drying the powder & reducing it to an ultra fine state, mixing the powder with water, charging the wet mix into Radial Noodler, collecting the uniformly cut to the size noodles and gravity fed into the Spheroidizer till spheroidal shaped dye granules are formed which are further dried to produce uniformly sized spheroidal dye granules.

This inventive manufacturing process differs from the prior arts discussed above on the following aspects:

1. The process of manufacturing spheroidal food dye granule does not use any extrusion die plate to produce strands (U.S. Pat. No. 5,507,991).

Explanation: The wetted dye mix is pressed between two counter rotating rollers, one of which has perforations of uniform diameter through the wall. This process does not employ a sifting step to convert stranded dye product to granular dye product. The uniform sized spheroidal dye granules are produced using centrifugal spheroidizing process which is substantially different from the process of extrusion.

2. Besides the food dye in powder form and water as the raw material, no intoxicating elements like surfactants, fillers, supplementary additives, charging agents, humidification agents, disintegrating agents, thickening agents, dessication agents or surface active agents are added or handled during the manufacturing process.

3. Spheroidizer is an high speed operating equipment rotating from 500 rpm to 1500 rpm which forms a twisted rope flow formation and is the base of spheroidal shape dye granule formation.

4. The physical and chemical properties of the uniformly sized, spheroidal shaped food dye granule does not undergo any change as no chemical reaction is involved in the manufacturing process (WO 98/17729). There is no conveying device or shaping section in the equipment used for the manufacture of spheroidal food dye granule.

5. The heating and rotational movement of the Spheroidizer alone control the process of Spheroidization as perthe manufacturing process of spheroidal food dye granule and that the counter rotating horizontal and vertical arms (U.S. Pat. No. 3,579,719) creating undulating rotatory force to transform segments to spherical granules is absent in this process.

6. As per the manufacturing process of Spheroidal food dye granule, no mechanical working to plasticize the mass is required (U.S. Pat. No. 3,775,331). There is no dish construction in the Spheroidizer, neither is there any bed formation at the bottom of the plate and retention over frictional surfaces. The spheroidal food dye granules are not treated for any surface coating. Also no water is added beyond mixing or blending step.

7. As per the manufacturing process of spheroidal food dye granule, matrix plate construction is not applicable (FR 2645 164).

Explanation: The noodles are formed by the counter rotating rollers one of which has perforations. The process of Spheroidization is accomplished by drying the moisture content at controlled temperature conditions.

### BRIEF DESCRIPTION OF THE DRAWINGS

Further objects and features of the present invention are described in the following Description of the Preferred Embodiment of the invention, and in the drawing figures wherein:

FIG. 1A is a side elevation view of a Compactor apparatus used in producing granular food dyes;

FIG. 1B is a side elevation view of a Cadmill apparatus used in producing granular food dyes;

FIG. 1C is a side elevation view of a Vibratory Sifter apparatus of the type used in producing granular food dyes;

FIG. 2A is a side elevation view of a Blender apparatus of the type used in the present invention;

FIG. 2B is a side elevation view of a Radial Noodler apparatus of the type used in the present invention;

FIG. 2C is a side elevation view of a Spheroidizer apparatus of the type used in the present invention;

FIG. 2D is a side elevation view of a Drier apparatus of the type used in the present invention;

FIG. 2E is a side elevation view of a Vibratory Sifter apparatus of the type used in the present invention;

FIG. 3 is a perspective view of the roller assembly contained in the Radial Noodler;

FIG. 4 is a fragmentary cross-sectional view of the roller assembly contained in the Radial Noodler of FIG. 3;

FIG. 5A is a cross-sectional view of the Spheroidizer apparatus;

FIG. 5B is a cut-away view of the Spheroidizer apparatus;

FIG. 5C is a cross-sectional view of the Spheroidizer apparatus; and

FIG. 5D is a cut-away view of the Spheroidizer apparatus.

### A DESCRIPTION OF A PREFERRED EMBODIMENT

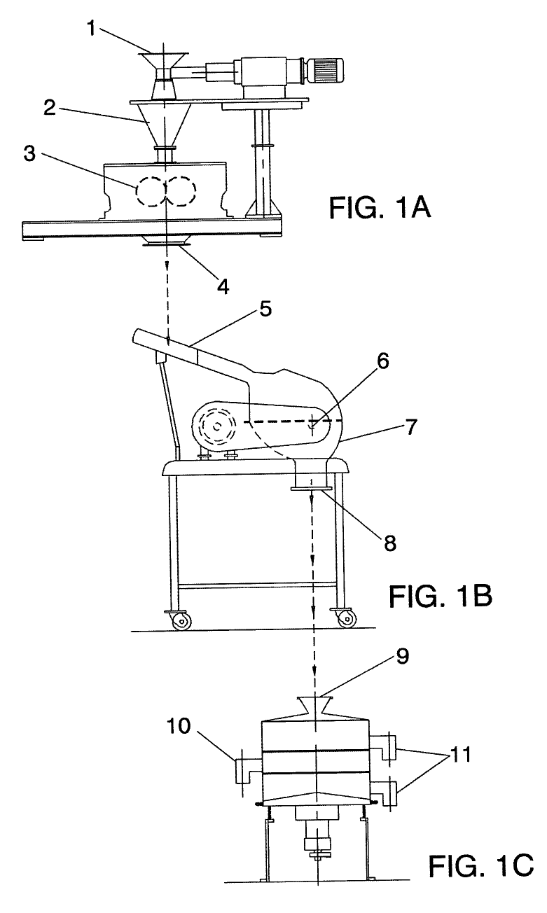

Under the known process of manufacture of a food dye granule, raw material which is generally in liquid form is dried in the spray drier to obtain a powder form of raw material. This powder form of raw material which is in an agglomerated state is subjected to pulverization in the pulveriser to uniformly reduce it to a uniform ultra fine state. This spray dried ultra fine powder is charged in the Compactor inlet FIG. 1(1) by controlling the speed of the inlet feed screw FIG. 1(2) for controlled feed through the fixed compactor inlet roller gap FIG. 1(3) which are rotating axially in forward direction. This powder is compacted into flakes. The flake shaped product is then transferred from compactor outlet FIG. 1(4) into Cadmill inlet FIG. 1(5), where they are struck by Cadmill shaft FIG. 1(6) and broken in the Cadmill body FIG. 1(7) by blades fixed on the Cadmill to produce granules of various sizes. The granules so formed are collected through Cadmill outlet FIG. 1(8) and then sieved through a Vibratory Sifter FIG. 1(9) to collect similar sized but irregular shaped granules through grain outlet FIG. 1(10). The granules formed have a tendency to disintegrate into dust form which is an undesired feature. The granules so obtained by the above process have an affinity to absorb moisture. The granules of undesired size like the coarse and very fine sizes are collected through the recycle outlet FIG. 1(11).

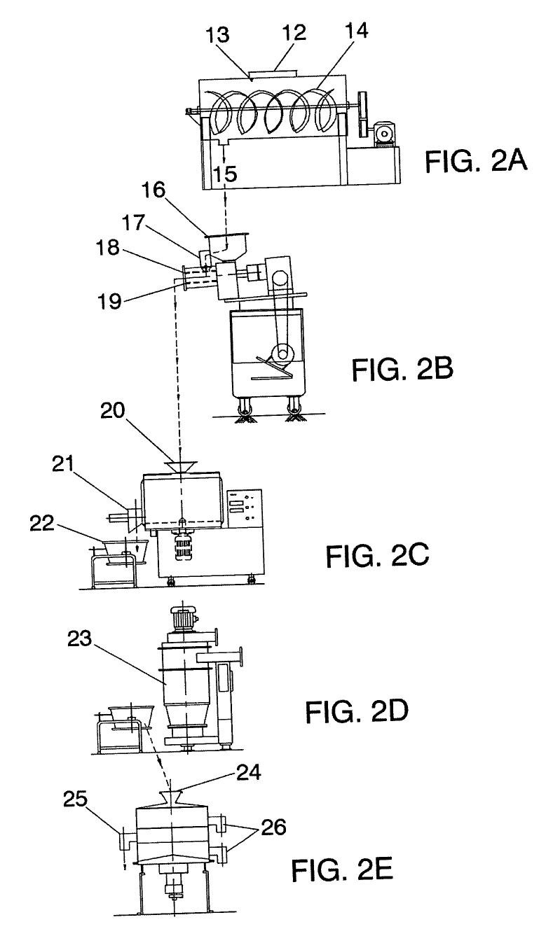

Owing to certain shortfalls under the prior art, this invention comes out with a new process wherein the raw material which is in the form of liquid is subjected to drying in the spray drier to obtain a powder form of raw material. The resultant product is a mixture of powder in fine and agglomerated state which is pulverized (grinded) in the Pulveriser to uniformly reduce the particle size to ultra fine state. Pre-weighed powder is gravity fed to the Blender inlet FIG. 2(12). In the blender, the ultra fine powder is mixed with water at 60 rpm for 15 minutes by the blender fluets FIG. 2(14). The temperature of the blender is maintained at 35° C. to 80° C. Water is sprayed into the blender through the spray nozzle FIG. 2(13).

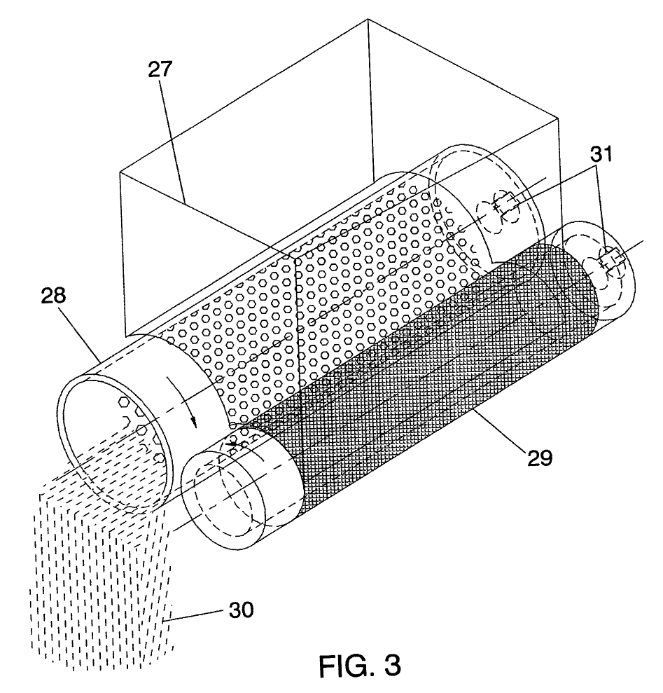

The wet mix discharged through the blender discharge FIG. 2(15) is then charged into the Radial Noodler FIG. 2(16) through the Hopper. Through the Hopper, the wet mix passes through the perforated roller inlet FIG. 2(17) on to the roller FIG. 2(18) consisting of Perforated Roller FIG. 3(28) and Knurled Roller Assembly FIG. 3(29).

The Perforated Roller Assembly has a multiple number of perforations FIG. 3(28) with each perforation having an entry bore and an exit bore which extends from the outside of the perforated roller to the inside of the perforated roller. The perforated roller and the knurled roller are key mounted on separate drive shafts FIG. 3(31) rotating in inward direction.

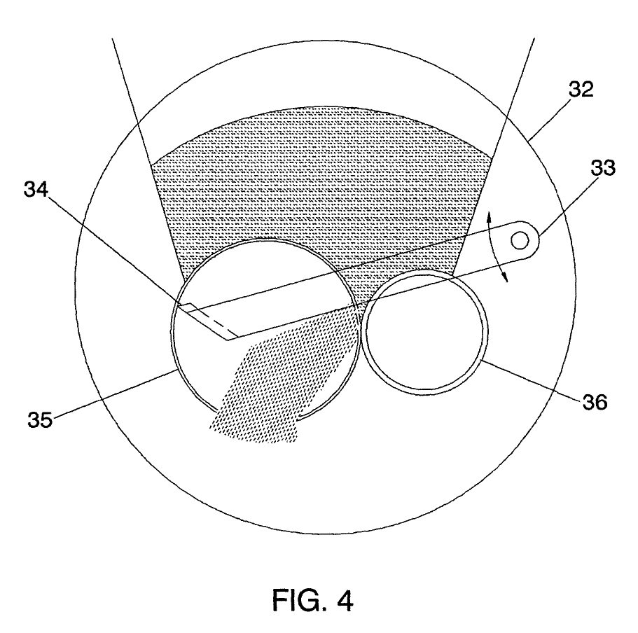

The wet mix when charged through the roller FIG. 3(27) results in the formation of noodles FIG. 3(30). The noodles produced are simultaneously cut into desired lengths with the help of an adjustable cutter (to control the size of the noodles uniformly) FIG. 4(34) fixed on the Perforated Roller Assembly FIG. 4(35,36). This adjustable cutter is fitted by an adjustable screw FIG. 4(33) on the noodler body FIG. 4(32).

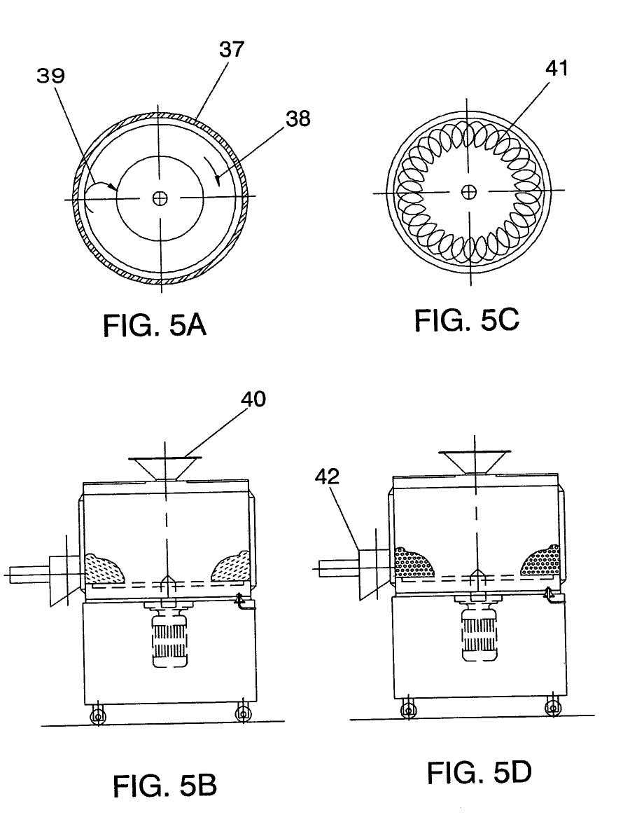

The non dusty, uniform sized noodles are collected from noodle outlet FIG. 2(19) in the Hopper FIG. 2(20). The uniform sized noodles are gravity charged into the Spherodizer FIG. 5(40). The Spherodizer is preheated from about 40° C. to 85° C. which is maintained through out the process of Spherodization through the Jacket provided FIG. 5(37).

In the Spherodizer, the noodles are rotated in a fixed bowl with a bottom of chequered plate FIG. 5(38) rotating at about 500 rpm to 1500 rpm. The noodles while rotating, collide against the wall of the bowl and return towards the center of the bowl FIG. 5(39) and then again move towards the wall producing uniformly spherical granules of highly compact nature due to centrifugal action and impact forces FIG. 5(41). The spheroids thus formed are collected through the spheroids outlet FIG. 2(21), FIG. 5(42), in the collection bin FIG. 2(22).

The size of the spheroids is governed by the screen size of the Perforated Roller assembly of the Radial Noodler. The moisture content of the product ranges from about 15% to 40% before drying. The uniform sized, spherical shaped product obtained is dried in a Drier FIG. 2(23) by fluidization method wherein the moisture content of spheroidal granules thus produced is reduced. These spheroidal granules so formed are sieved through the vibratory sifter FIG. 2(24) to collect more uniform sized, spherical shaped granules through grain outlet FIG. 2(25). The granules of undesired size like the coarse and very fine sizes are collected through the recycle outlet FIG. 2(26).

The method and apparatus used in the invention are very effective and have a significant contribution to the production of the new food color granules (comprising of FD & C dyes, Acid dyes, D & C dyes, artificial dyes and blends of artificial dyes). They are very simple in the manner of their performance and/or operation.

The salient features of the present inventions which distinguish it from the prior granules of artificial food colors (comprising of FD & C dyes, Acid dyes, D & C dyes, artificial dyes and blends of artificial dyes).

1. The method and apparatus adopted for the invention have resulted in a uniformly sized, spherical product which reduces friability to a great extent during handling and transportation.

2. The invention is cost effective than other products in use.

3. The invention is more efficient with negligible losses than other known methods in use.

Having thus described the invention, what is claimed as new and desired to be secured by Letters Patent is as follows:

1. A process of manufacturing spheroidal shaped food dye granules comprising the following steps:
i) mixing powdered food color in liquid media to form a desired wet mix at premaintained temperature level;
ii) charging the premixed food color into a Radial Noodlerfitted with a perforated roller assembly with an in-built adjustable cutter to obtain uniform sized noodles;
iii) gravity charging the uniform size noodles into a Spheroidizer at premaintained temperature level containing a bowl with a rotatory chequered plate bottom, wherein the noodles are subjected to a centrifugal action and impact forces rotating at the rate of 500 rpm to 1500 rpm for making the noodles to continuously collide against a wall of the bowl and return towards the center of the chequered plate and again on to the wall of the bowl, thus transforming the noodle into spheroidal shaped granules;
iv) drying the uniform sized spheroidal shaped food dye granules.

2. A process according to claim 1 characterized in that the food dye granules are formed from FD&C dyes, D&C dyes, Acid dyes, artificial dyes and blends of artificial dyes.

3. A process according to claim 1 characterized in that the wet mix is gravity charged into the Radial Noodler which comprises a Perforated Roller Assembly having multiple perforations resulting in the transformation of the wet mix into uniform sized noodles of the desired size.

4. A process according to claim 1 characterized in that the Perforated Roller Assembly consists of two counter rotating rollers in inward direction, one of which has identical perforations of equal triangular pitch and the second with Knurled surface having rotatory movement in opposite direction of each other such that noodles of uniform length are produced and cut to desired size with an in-built adjustable cutter.

5. A process according to claim 1 characterized in that the noodles of uniform length and diameter so formed are processed in the spherodizer which is responsible for the formation of the spheroidal shaped dye granules that eliminates dust formation, the size of the granule being governed by the perforations on the Perforated Roller.

6. A process according to claim 1 characterized in that the uniform sized noodles are charged onto the centrifugal rotating motion of the pre-heated rotating chequered plate present within the spherodizer at the rate of 500 rpm to 1500 rpm which results in the formation of uniform sized, uniform shaped, dust free spheroidal dye granules.

7. A process according to claim 1 characterized in that the spheroidal shaped dye granules comprise a range of sizes between 0.8128 mm (0.032 inches) to 7.112 mm (0.28 inches).

8. A process according to claim 1 characterized in that the perforations in the Perforated Roller extend from outside cylindrical face to inside cylindrical face of straight bore of size 0.8128 mm (0.032 inches) or any step ranging till 7.112 mm (0.28 inches).

9. A process according to claim 1 characterized in that the Perforated Roller as well as the Knurled Roller is key mounted on separate drive shafts rotating in inward direction.
